(19) United States
(12) Patent Application Publication
(10) Pub. No.: US 2015/0016364 A1
(43) Pub. Date: Jan. 15, 2015

(54) Method And Apparatus For Facilitating Remote Participance In A Community

(71) Applicants: Jari Henrik Junell, Espoo (FI); Lauri Heikki Laitinen, Espoo (FI); Juha Johannes Salokannel, Tammerfors (FI); Sverre Slotte, Esbo (FI)

(72) Inventors: Jari Henrik Junell, Espoo (FI); Lauri Heikki Laitinen, Espoo (FI); Juha Johannes Salokannel, Tammerfors (FI); Sverre Slotte, Esbo (FI)

(73) Assignee: NOKIA CORPORATION, Espoo (FI)

(21) Appl. No.: 14/346,489

(22) PCT Filed: Sep. 22, 2011
(86) PCT No.: PCT/IB2011/054186

§ 371 Date: Mar. 21, 2014

(51) Int. Cl. H04W 76/02; H04W 84/18; H04W 4/02

(52) U.S. Cl. CPC H04W 76/021; H04W 4/02; H04W 84/18
USPC 370/329

(57) ABSTRACT

A method and apparatus are provided for facilitating remote participance in a community. A method may include determining, at a network node accessible via a structured network, a community identifier for an ad hoc community formed at least in part by a plurality of terminals at a first location using a proximity-based wireless communication technology to communicate with each other. The method may further include causing storage at the network node of the determined community identifier and associated membership information for the community. The membership information may include contact information associated with at least one of the plurality of terminals 10. A corresponding apparatus is also provided.

### TECHNOLOGICAL FIELD

Example embodiments of the present invention relate generally to communications technology and, more particularly, relate to a method and apparatus for facilitating remote participance in a community.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer and providing convenience to users.

Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds. Consumers may accordingly use their mobile computing devices to access services and communicate with other devices over mobile networks at a variety of locations.

### BRIEF SUMMARY

A system, method, and apparatus are herein provided for facilitating remote participance in a community. Systems, methods, and apparatuses in accordance with various embodiments may provide several advantages to computing devices, computing device users, service providers, and consumers. For example, some example embodiments provide a network node configured to store a community identifier and associated membership information for a community, which may have been formed at least in part by a plurality of terminals at a first location using a proximity-based wireless communication technology to communicate with each other.

In some such example embodiments, the network node may be configured to use the stored community identifier and associated membership information to enable a remote terminal at a second location to participate in the community, even though the second location may be outside of a range of the proximity-based communication technology used by the plurality of terminals at the first location. Accordingly, such example embodiments may enable remote users to participate in ad hoc location-based communities, even if located at another location.

Additionally or alternatively, in some example embodiments, the network node may be configured to use the stored community identifier and associated membership information to enable data to be sent to community members even after the terminals have left the first location such that data may no longer be exchanged between community members via the proximity-based wireless communication technology. Accordingly, by storing the community identifier and associated membership information, some example embodiments may facilitate re-establishing and/or maintaining a location-based community even after dispersal of the participants in the community from the location at which the community was formed.

In a first example embodiment, a method is provided, which may comprise determining, at a network node accessible via a structured network, a community identifier for an ad hoc community formed at least in part by a plurality of terminals at a first location using a proximity-based wireless communication technology to communicate with each other. The method of this example embodiment may further comprise causing storage at the network node of the determined community identifier and associated membership information for the community. The membership information may comprise contact information associated with at least one of the plurality of terminals.

In a second example embodiment, an apparatus comprising at least one processor and at least one memory storing computer program code is provided. The at least one memory and stored computer program code may be configured, with the at least one processor, to cause the apparatus of this example embodiment to at least perform determining a community identifier for an ad hoc community formed at least in part by a plurality of terminals at a first location using a proximity-based wireless communication technology to communicate with each other. The apparatus may be accessible via a structured network. The at least one memory and stored computer program code may be configured, with the at least one processor, to further cause the apparatus of this example embodiment to perform causing storage of the determined community identifier and associated membership information for the community. The membership information may comprise contact information associated with at least one of the plurality of terminals.

In a third example embodiment, an apparatus is provided that may comprise means for determining, at a network node accessible via a structured network, a community identifier for an ad hoc community formed at least in part by a plurality of terminals at a first location using a proximity-based wireless communication technology to communicate with each other. The apparatus of this example embodiment may further comprise means for causing storage at the network node of the determined community identifier and associated membership information for the community. The membership information may comprise contact information associated with at least one of the plurality of terminals.

In a fourth example embodiment, a method is provided, which may comprise causing a first terminal located at a first location to use a proximity-based wireless communication technology to participate in an ad hoc community formed at least in part by a plurality of terminals at the first location using the proximity-based wireless communication technology to communicate with each other. The method of this example embodiment may further comprise causing the first terminal to inform a network node via a structured network of the community and membership information for the community, thereby causing the network node to store a community identifier and associated membership information for the community. The membership information may comprise contact information associated with at least one of the plurality of terminals at the first location.

In a fifth example embodiment, an apparatus comprising at least one processor and at least one memory storing computer program code is provided. The at least one memory and stored computer program code may be configured, with the at least one processor, to cause the apparatus of this example embodiment to at least perform causing a first terminal located at a first location to use a proximity-based wireless communication technology to participate in an ad hoc community formed at least in part by a plurality of terminals at the first location using the proximity-based wireless communication technology to communicate with each other. The at least one memory and stored computer program code may be configured, with the at least one processor, to further cause the apparatus of this example embodiment to perform causing the first terminal to inform a network node via a structured network of the community and membership information for the community, thereby causing the network node to store a community identifier and associated membership information for the community. The membership information may comprise contact information associated with at least one of the plurality of terminals at the first location.

In a sixth example embodiment, an apparatus is provided that may comprise means for causing a first terminal located at a first location to use a proximity-based wireless communication technology to participate in an ad hoc community formed at least in part by a plurality of terminals at the first location using the proximity-based wireless communication technology to communicate with each other. The apparatus of this example embodiment may further comprise means for causing the first terminal to inform a network node via a structured network of the community and membership information for the community, thereby causing the network node to store a community identifier and associated membership information for the community. The membership information may comprise contact information associated with at least one of the plurality of terminals at the first location.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a system for facilitating remote participance in a community according to some example embodiments;

FIG. 2 is a schematic block diagram of a mobile terminal according to some example embodiments;

FIG. 3 illustrates a block diagram of a terminal apparatus according to some example embodiments;

FIG. 4 illustrates a block diagram of a network node apparatus according to some example embodiments;

FIG. 5 illustrates an example of facilitating remote participance in a community according to some example embodiments;

FIG. 6 illustrates an example of maintaining a community according to some example embodiments;

FIG. 7 illustrates a flowchart according to an example method for facilitating remote participance in a community according to some example embodiments; and

FIG. 8 illustrates a flowchart according to another example method for facilitating remote participance in a community according to some example embodiments.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Users having mobile computing devices within sufficient proximity of each other may establish ad hoc communities by which they may wirelessly exchange data and engage in various social activities. In this regard, the mobile computing devices may be configured to use a proximity-based communication technology, such as various radio frequency signaling technologies having a proximity-limited effective range (for example, Bluetooth, Wi-Fi signaling, various Institute of Electrical and Electronics Engineers 802.11 and/or 802.15 techniques, and/or the like), to establish an ad hoc local community when the devices are within sufficient proximity of each other to communicate via the proximity-based communication technology. However, the nature of these local communities may be temporary, as membership in the community may be dissolved when the user moves out of the requisite proximity to the other member(s) of the community. In this regard, a user having a computing device located at a location outside of range of the proximity-based communication technology used for communication between members of the local community may not be able to participate in the community. As such, some example embodiments facilitate remote participance in a community, such as a local ad hoc community formed at least in part by a plurality of terminals at a first location using a proximity-based wireless communication technology to communicate with each other.

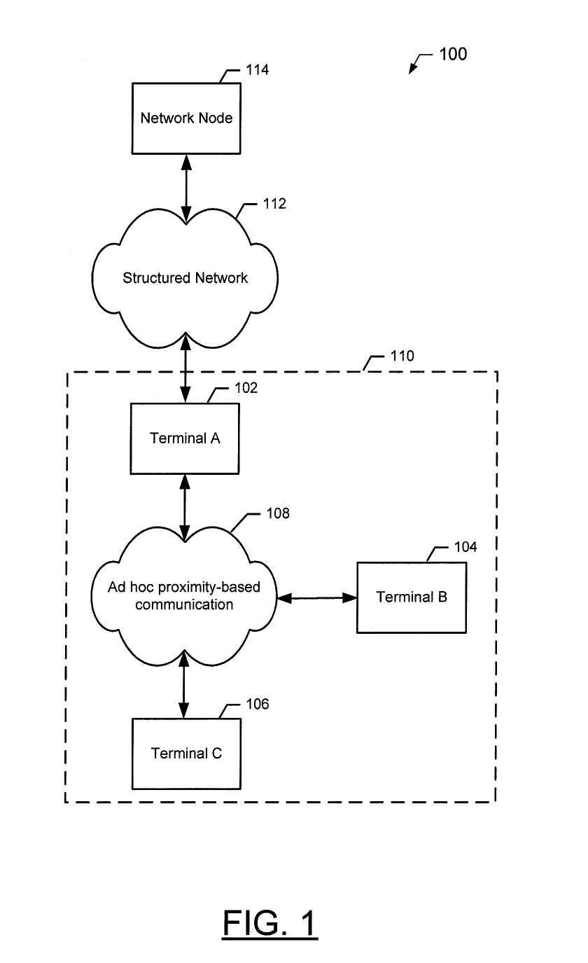

FIG. 1 illustrates a diagram of a system 100 for facilitating remote participance in a community according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for facilitating remote participance in a community, numerous other configurations may also be used to implement embodiments of the present invention.

In some example embodiments, the system 100 may include a local ad hoc community 110. The community 110 may be formed by a plurality of computing devices at a location that are within sufficient proximity of each other to communicate using a proximity-based communication technology. For example, a community 110 may be formed by users having compatible computing devices at a sporting event or other gathering where there may be users within sufficient proximity of each other. Three computing devices, the terminal A 102, terminal B 104, and terminal C 106, are illustrated as being members of the community 110 in the system 100 by way of example. However, it will be appreciated that the community 100 and/or other such local communities that may be formed in accordance with various example embodiments may include any number of computing devices.

As illustrated in FIG. 1, the computing devices forming the community 110 (for example, the terminal A 102, terminal B 104, and terminal C 106) may communicate via ad hoc proximity-based communication 108. This proximity-based communication may comprise the computing devices forming an ad hoc mesh network and/or communicating via one or more wireless communication links using a proximity-based communication technology. Such proximity-based communications technology may comprise any wireless communications technology by which two or more computing devices may communicate when they are within a proximate range of each other (for example, within a communications or signaling range of the proximity-based communications technology). By way of non-limiting example, such proximity-based communications technology may comprise Bluetooth, a communications technique implementing any version of the Institute of Electrical and Electronics Engineers (IEEE) 802.15 standard, ZigBee, Ultra-Wideband, a near field communications technology, infrared, a wireless local area network (WLAN) communications technology, signaling using any version of the IEEE 802.11 standard, any wireless personal area networking (PAN) technology, or the like. In some example embodiments, the community 110 may be formed using ad hoc proximity-based communication in accordance with Nokia® Instant Community technology.

The system 100 may further comprise a network node 114 that may be accessible via a structured network. As will be described further herein below, the network node 114 may comprise any computing device or plurality of computing devices which may store a community identifier and associated membership information for a community, such as the community 110 in accordance with one or more example embodiments. The network node 114 of some example embodiments may be configured to facilitate remote participance in a community on the basis of this stored information, as will be described further herein below. By way of non-limiting example, the network node 114 may be embodied as one or more servers, a server cluster, a cloud computing infrastructure, one or more desktop computers, one or more laptop computers, one or more network nodes, multiple computing devices in communication with each other, a chipset, an apparatus comprising a chipset, any combination thereof, and/or the like.

The structured network 112 may comprise any structured network. By way of non-limiting example, the structured network 112 may comprise one or more wireless networks (for example, a cellular network, a structured wireless local area network, wireless metropolitan area network, and/or the like), one or more wireline networks, or some combination thereof, and in some embodiments may comprise at least a portion of the internet.

In some example embodiments, one or more of the computing devices that are members of the community 110 may be configured to access the structured network 112 and communicate with the network node 114 via the structured network 112. By way of example, the terminal A 102 is illustrated as being connected to the structured network 112 in FIG. 1. In this regard, the terminal A 102 may, in some example embodiments, be connected to the a cellular network, the internet, and/or other structured network while communicating with one or more other members of the community 110 via ad hoc proximity-based communication 108.

A computing device participating in the community 110, such as the terminal A 102, terminal B 104, and/or terminal C 106, may comprise any computing device configured to communicate with another computing device through use of a proximity-based communication technology. By way of non-limiting example, such a computing device may be embodied as a computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), a chipset, an apparatus comprising a chipset, any combination thereof, and/or the like.

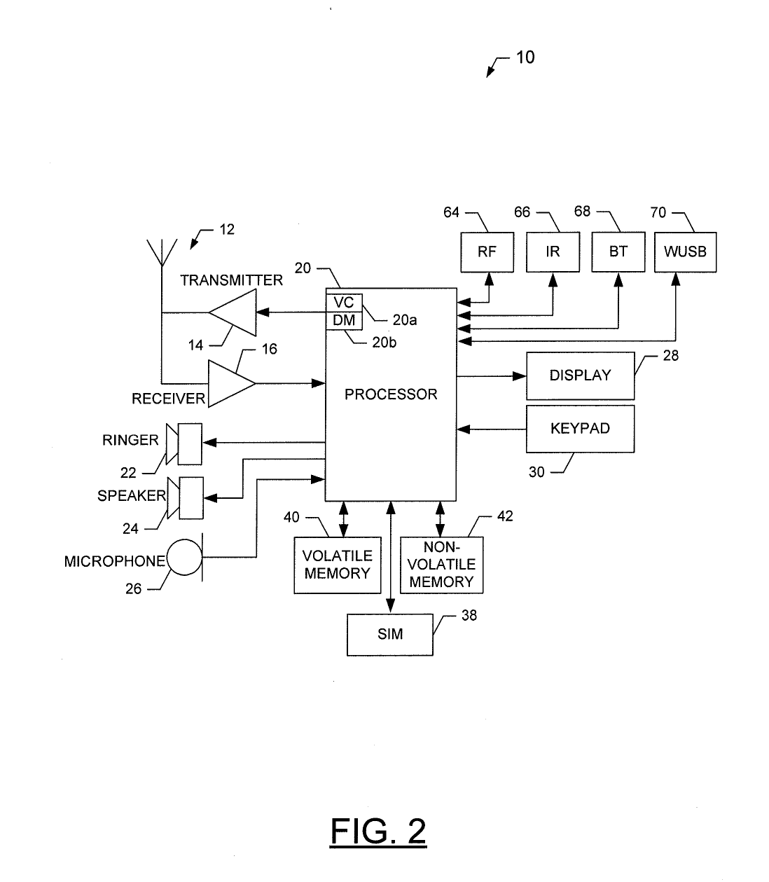

According to some example embodiments, a computing device configured to participate in the community 110 (for example, the terminal A102, terminal B 104, terminal C 106, and/or the like) may be embodied as a mobile terminal, such as that illustrated in FIG. 2. In this regard, FIG. 2 illustrates a block diagram of a mobile terminal 10 representative of some embodiments of a computing device configured to participate in the community 110 (for example, the terminal A102, terminal B 104, terminal C 106, and/or the like). It should be understood, however, that the mobile terminal 10 illustrated and hereinafter described is merely illustrative of one type of computing device that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). The mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a removable or non-removable subscriber identity module (SIM) 38, a soft SIM 38, a fixed SIM 38, a removable or non-removable universal subscriber identity module (USIM) 38, a soft USIM 38, a fixed USIM 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40, non-volatile memory 42 may also include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

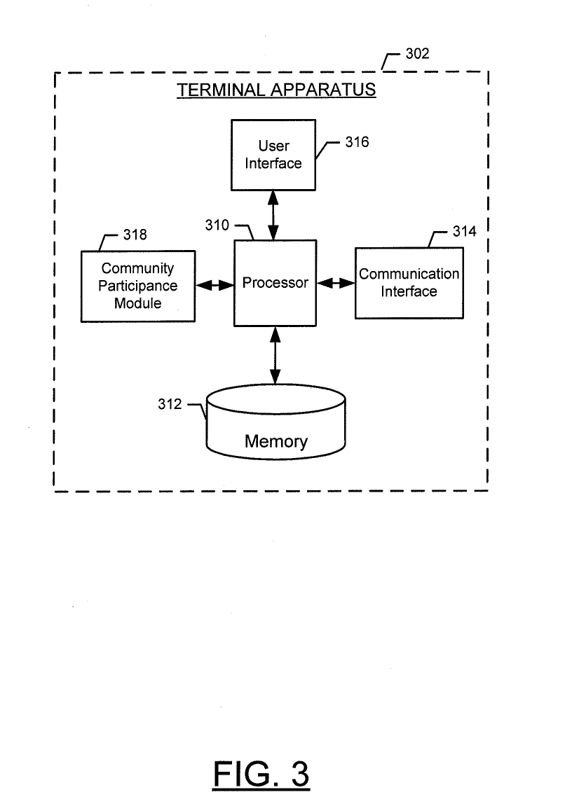

Referring now to FIG. 3, FIG. 3 illustrates a block diagram of a terminal apparatus 302 according to some example embodiments. The terminal apparatus 302 may comprise an apparatus, which may be implemented on a computing device which may be configured to participate in a community, such as the community 110 in accordance with some example embodiments. Accordingly, the terminal apparatus 302 may be implemented on a terminal A 102, terminal B 104, terminal C 106, and/or the like in accordance with some example embodiments.

In some example embodiments, the terminal apparatus 302 may include various means for performing the various functions herein described. These means may comprise one or more of a processor 310, memory 312, communication interface 314, user interface 316, or community participance module 318. The means of the terminal apparatus 302 as described herein may be embodied as, for example, circuitry, hardware elements (for example, a suitably programmed processor, combinational logic circuit, and/or the like), a computer program product comprising a computer-readable medium (for example memory 312) storing computer-readable program instructions (for example, software or firmware) that are executable by a suitably configured processing device (for example, the processor 310), or some combination thereof.

In some example embodiments, one or more of the means illustrated in FIG. 3 may be embodied as a chip or chip set. In other words, the terminal apparatus 302 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 310, memory 312, communication interface 314, user interface 316, and/or community participance module 318 may be embodied as a chip or chip set. The terminal apparatus 302 may therefore, in some example embodiments, be configured to implement example embodiments of the present invention on a single chip or as a single “system on a chip.” As another example, in some example embodiments, the terminal apparatus 302 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 310 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 3 as a single processor, in some example embodiments the processor 310 may comprise a plurality of processors. The plurality of processors may be in operative communication with each other and may be collectively configured to perform one or more functionalities of the terminal apparatus 302 as described herein. The plurality of processors may be embodied on a single computing device or distributed across a plurality of computing devices collectively configured to function as the terminal apparatus 302. In embodiments wherein the terminal apparatus 302 is embodied as a mobile terminal 10, the processor 310 may be embodied as or may comprise the processor 20. In some example embodiments, the processor 310 is configured to execute instructions stored in the memory 312 or otherwise accessible to the processor 310. These instructions, when executed by the processor 310, may cause the terminal apparatus 302 to perform one or more of the functionalities of the terminal apparatus 302 as described herein. As such, whether configured by hardware or software methods, or by a combination thereof, the processor 310 may comprise an entity capable of performing operations according to embodiments of the present invention while configured accordingly. Thus, for example, when the processor 310 is embodied as an ASIC, FPGA or the like, the processor 310 may comprise specifically configured hardware for conducting one or more operations described herein. Alternatively, as another example, when the processor 310 is embodied as an executor of instructions, such as may be stored in the memory 312, the instructions may specifically configure the processor 310 to perform one or more algorithms and operations described herein.

The memory 312 may comprise, for example, volatile memory, non-volatile memory, or some combination thereof. In this regard, the memory 312 may comprise a non-transitory computer-readable storage medium. Although illustrated in FIG. 3 as a single memory, the memory 312 may comprise a plurality of memories. The plurality of memories may be embodied on a single computing device or may be distributed across a plurality of computing devices collectively configured to function as the terminal apparatus 302. In various example embodiments, the memory 312 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal apparatus 302 is embodied as a mobile terminal 10, the memory 312 may comprise the volatile memory 40 and/or the non-volatile memory 42. The memory 312 may be configured to store information, data, applications, instructions, or the like for enabling the terminal apparatus 302 to carry out various functions in accordance with various example embodiments. For example, in some example embodiments, the memory 312 may be configured to buffer input data for processing by the processor 310. Additionally or alternatively, the memory 312 may be configured to store program instructions for execution by the processor 310. The memory 312 may store information in the form of static and/or dynamic information. This stored information may be stored and/or used by the community participance module 318 during the course of performing its functionalities.

The communication interface 314 may be embodied as any device or means embodied in circuitry, hardware, a computer program product comprising a computer-readable medium (for example memory 312) storing computer-readable program instructions (for example, software or firmware) that are executable by a suitably configured processing device (for example, the processor 310), or a combination thereof that is configured to receive and/or transmit data from/to another computing device. According to some example embodiments, the communication interface 314 may be at least partially embodied as or otherwise controlled by the processor 310. In this regard, the communication interface 314 may be in communication with the processor 310, such as via a bus. The communication interface 314 may include, for example, an antenna, a transmitter, a receiver, a transceiver and/or supporting hardware or software for enabling communications with one or more computing devices. The communication interface 314 may be configured to receive and/or transmit data using any protocol that may be used for communications between computing devices. In this regard, the communication interface 314 may be configured to receive and/or transmit data using any protocol that may be used for transmission of data over a wireless network, wireline network, some combination thereof, or the like by which the terminal apparatus 302 and one or more computing devices or computing resources may be in communication. As an example, the communication interface 314 may be configured to support communication with another terminal apparatus 302 using a proximity-based communication technology. Accordingly, the communication interface 314 may be configured to facilitate establishment and participation in a local community, such as the community 110. As a further example, the communication interface 314 may be configured to enable communication between the terminal apparatus 302 and another computing device, such as the network node 114, via the structured network 112. The communication interface 314 may additionally be in communication with the memory 312, user interface 316, and/or community participance module 318, such as via a bus.

The user interface 316 may be in communication with the processor 310 to receive an indication of a user input and/or to provide an audible, visual, mechanical, or other output to a user. As such, the user interface 316 may include, for example, a keyboard, a mouse, a joystick, a display, a touch screen display, a microphone, a speaker, and/or other input/output mechanisms. In embodiments wherein the user interface 316 comprises a touch screen display, the user interface 316 may additionally be configured to detect and/or receive an indication of a touch gesture or other input to the touch screen display. The user interface 316 may be in communication with the memory 312, communication interface 314, and/or community participance module 318, such as via a bus.

The community participance module 318 may be embodied as various means, such as circuitry, hardware, a computer program product comprising a computer-readable medium (for example memory 312) storing computer-readable program instructions (for example, software or firmware) that are executable by a suitably configured processing device (for example, the processor 310), or some combination thereof and, in some example embodiments, may be embodied as or otherwise controlled by the processor 310. In embodiments wherein the community participance module 318 is embodied separately from the processor 310, the community participance module 318 may be in communication with the processor 310. The community participance module 318 may further be in communication with one or more of the memory 312, communication interface 314, or user interface 316, such as via a bus.

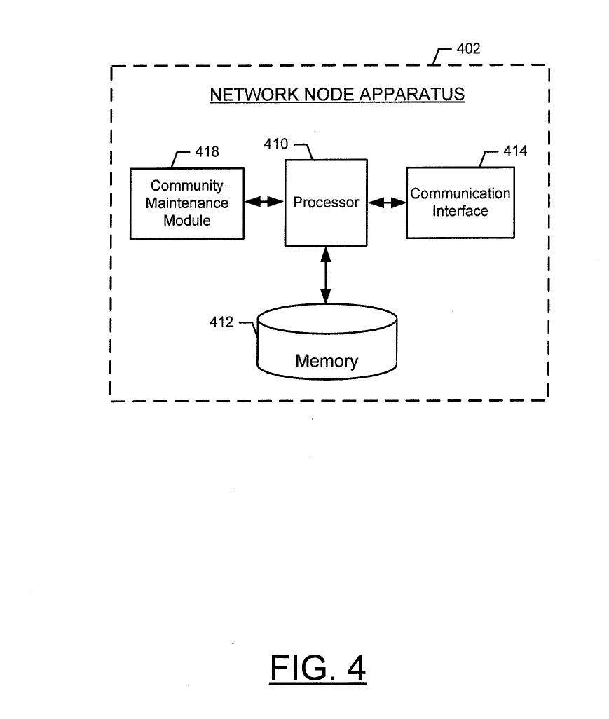

Referring now to FIG. 4, FIG. 4 illustrates a block diagram of a network node apparatus 402 according to some example embodiments. In this regard, the network node apparatus 402 illustrates an apparatus that may comprise a network node 114 in accordance with some example embodiments. In some example embodiments, the network node apparatus 402 may include various means for performing the various functions herein described. These means may comprise one or more of a processor 410, memory 412, communication interface 414, or community maintenance module 418. The means of the network node apparatus 402 as described herein may be embodied as, for example, circuitry, hardware elements (for example, a suitably programmed processor, combinational logic circuit, and/or the like), a computer program product comprising a computer-readable medium (for example memory 412) storing computer-readable program instructions (for example, software or firmware) that are executable by a suitably configured processing device (for example, the processor 410), or some combination thereof.

In some example embodiments, one or more of the means illustrated in FIG. 4 may be embodied as a chip or chip set. In other words, the network node apparatus 402 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 410, memory 412, communication interface 414, and/or community maintenance module 418 may be embodied as a chip or chip set. The network node apparatus 402 may therefore, in some example embodiments, be configured to implement embodiments of the present invention on a single chip or as a single “system on a chip.” As another example, in some example embodiments, the network node apparatus 402 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 410 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 4 as a single processor, in some example embodiments the processor 410 may comprise a plurality of processors. The plurality of processors may be in operative communication with each other and may be collectively configured to perform one or more functionalities of the network node apparatus 402 as described herein. The plurality of processors may be embodied on a single computing device or distributed across a plurality of computing devices collectively configured to function as the network node apparatus 402. In some example embodiments, the processor 410 is configured to execute instructions stored in the memory 412 or otherwise accessible to the processor 410. These instructions, when executed by the processor 410, may cause the network node apparatus 402 to perform one or more of the functionalities of the network node apparatus 402 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an ASIC, FPGA or the like, the processor 410 may comprise specifically configured hardware for conducting one or more operations described herein. Alternatively, as another example, when the processor 410 is embodied as an executor of instructions, such as may be stored in the memory 412, the instructions may specifically configure the processor 410 to perform one or more algorithms and operations described herein.

The memory 412 may comprise, for example, volatile memory, non-volatile memory, or some combination thereof. In this regard, the memory 412 may comprise a non-transitory computer-readable storage medium. Although illustrated in FIG. 4 as a single memory, the memory 412 may comprise a plurality of memories. The plurality of memories may be embodied on a single computing device or may be distributed across a plurality of computing devices collectively configured to function as the network node apparatus 402. In various example embodiments, the memory 412 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 412 may be configured to store information, data, applications, instructions, or the like for enabling the network node apparatus 402 to carry out various functions in accordance with various example embodiments. For example, in some example embodiments, the memory 412 may be configured to buffer input data for processing by the processor 410. Additionally or alternatively, the memory 412 may be configured to store program instructions for execution by the processor 410. The memory 412 may store information in the form of static and/or dynamic information. This stored information may be stored and/or used by the community maintenance module 418 during the course of performing its functionalities.

The communication interface 414 may be embodied as any device or means embodied in circuitry, hardware, a computer program product comprising a computer readable medium (for example, the memory 412) storing computer readable program instructions that are executable by a suitably configured processing device (for example, the processor 410), or a combination thereof that is configured to receive and/or transmit data from/to another computing device. According to some example embodiments, the communication interface 414 may be at least partially embodied as or otherwise controlled by the processor 410. In this regard, the communication interface 414 may be in communication with the processor 410, such as via a bus. The communication interface 414 may include, for example, an antenna, a transmitter, a receiver, a transceiver and/or supporting hardware or software for enabling communications with one or more remote computing devices. The communication interface 414 may, for example, be configured to receive and/or transmit data using any protocol that may be used for communications between the network node apparatus 402 and another computing device, such as a terminal apparatus 302. In this regard, the communication interface 414 may be configured to receive and/or transmit data using any protocol that may be used for transmission of data over the structured network 112. The communication interface 414 may additionally be in communication with the memory 412, and/or community maintenance module 418, such as via a bus.

The community maintenance module 418 may be embodied as various means, such as circuitry, hardware, a computer program product comprising a computer readable medium (for example, the memory 412) storing computer readable program instructions that are executable by a suitably configured processing device (for example, the processor 410), or some combination thereof and, in some example embodiments, may be embodied as or otherwise controlled by the processor 410. In embodiments wherein the community maintenance module 418 is embodied separately from the processor 410, the community maintenance module 418 may be in communication with the processor 410. The community maintenance module 418 may further be in communication with one or more of the memory 412, or communication interface 414, such as via a bus.

The community participance module 318 associated with a terminal apparatus 302 may be configured to determine a presence of another computing device and/or an established community (for example, a community 110) within sufficient proximity of a proximity-based communication technology. For example, the community participance module 318 may be configured to determine a presence of another computing device and/or an established community by detecting and/or interpreting wireless signals and/or data that may be received via the communication interface 314 from a proximate device in accordance with a proximity-based communication technology. The community participance module 318 may be further configured to cause the terminal apparatus 302 to establish a community and/or join an existing community by communicating with one or more proximate computing devices using a proximity-based communication technology.

In this regard, using the example of FIG. 1 in some example embodiments wherein a terminal apparatus 302 is implemented on the terminal A 102, the community participance module 318 associated with the terminal A 102 may be configured to determine a presence of the terminal B 104, terminal C 106, and/or an existing established community including the terminal B 104 and terminal C 106 after entering the location of the local community 110. The community participance module 318 associated with terminal A 102 may be further configured to cause the terminal A 102 to join and/or establish the community 110 at least in part by causing the terminal A 102 to communicate with the terminal B 104 and/or terminal C 106 using a proximity-based communication technology.

The community participance module 318 of some example embodiments may be configured to cause the apparatus 302 to communicate with the network node 114 via the structured network 112. In this regard, one or more computing devices that are members of a community may be configured to access the structured network 112 to communicate with the network node 114 so as to facilitate remote participance in the community and/or maintenance of the community after one or more members of the community (for example, the terminal A 102, terminal B 104, terminal C 106, and/or the like) have left the location of the community (for example, the location at which the community 110 was formed). For example, using the example of FIG. 1, a community participance module 318 associated with the terminal A 102 may be configured to cause the terminal A 102 to communicate with the network node 114 via the structured network 112.

The community participance module 318 may be configured to inform the network node 114 of a community in which the terminal apparatus 302 may be participating and/or membership information for the community. In this regard, the community participance module 318 may, for example, be configured to inform the network node 114 of the community and/or of membership information for the community in response to formation of the community, in response to the terminal apparatus 302 joining the community, and/or the like.

In some example embodiments, participants in a community having a connection to the structured network 112 may individually inform the network node 114 of its membership in the community including, for example, contact information for the participating terminal. Such configurations may, for example, maintain privacy of individual community participants. Additionally or alternatively, in some example embodiments, a master terminal may be designated, which may be responsible for collecting and providing membership information to the network node. The master terminal may, for example, comprise the terminal that established the community, a terminal having a connection to the structured network 112, or the like.

The community maintenance module 418 that may be associated with the network node 114 of some example embodiments may be configured to receive a communication from a terminal apparatus 302 including information about a formed community and/or membership information for the community. The community maintenance module 418 may be configured to determine a community identifier for the community and cause the determined community identifier to be stored (for example, in the memory 412). The community identifier may, for example, comprise a resource identifier (for example, a uniform resource locator (URL) or the like), an alphanumeric identifier, an address, and/or other identifier by which the community may be identified and distinguished from other communities. In some example embodiments, the community maintenance module 418 may be configured to determine a community identifier by automatically assigning a community identifier to the community, such as in response to receipt of information about the community from a terminal apparatus 302. Additionally or alternatively, in some example embodiments, one or more participants participating in the community may select an identifier for the community and communicate the selected identifier to the network node apparatus 402. Thus, for example, the community maintenance module 418 may be configured to determine a community identifier received from, or otherwise referenced by, a terminal apparatus 302.

In some example embodiments, a community may have one or more community identifiers. For example, there may be a local identifier that may be determined by a community participance module 318 associated with a terminal participating in the community 110. In this regard, one or more terminals participating in the community 110 through use of proximity-based communication 108 may, for example, know the community by such a local identifier. In some such example embodiments having one or more community identifiers, there may also be a universal identifier, which may be determined by the community maintenance module 418 and maintained by the network node 114. This universal identifier may, for example, be used to access and/or distinguish the community outside of the context of the local community 110, such as over the structured network 112.

The community maintenance module 418 may be further configured to cause membership information for the community to be stored (for example, in the memory 412). The stored membership information may, for example, comprise membership information received from a terminal apparatus 302 and/or membership information determined based at least in part on community membership information that may be received from a terminal apparatus 302. The stored membership information may comprise contact information associated with the members of the community. In this regard, the contact information may comprise information enabling the participating members to be contacted such that data may be communicated to members of the community. As such, the contact information may comprise any address, identifier, and/or the like associated with a terminal participating in the community that enables information to be sent to a terminal participating in the community and/or to a user associated with a participating terminal. By way of example, the contact information may comprise a phone number, International Mobile Subscriber Identity (IMSI) associated with a participating terminal, an email address associated with a participating user, an Internet Protocol (IP) address associated with a participating terminal, a Domain Service Name (DSN) associated with a participating terminal, a SIP Universal Resource Identifier (URI), and/or the like.

In some example embodiments, a user may specify a preferred and/or prohibited contact method for data exchanged within a community in which the user is participating. Accordingly, in some example embodiments, the type of contact information stored and/or used by the community maintenance module 418 may be selected in accordance with user preferences.

In some example embodiments, the community maintenance module 418 may be configured to cause a community identifier for a community to be published such that it may be accessed via the structured network 112. In this regard, in some example embodiments, a computing device may access a published community identifier, such as over the structured network 112, to send data to members of the community. Thus, for example, as will be further described, in some example embodiments, a user of a remote terminal that may be at a location remote from the location at which the community was formed may access a published community identifier and choose to participate in the community using the community identifier. As another example, as will be further described, in some example embodiments, after one or more members of a community such as the community 110 has dispersed from the location at which the community was formed using proximity-based communications, a member may use the published community identifier to send data to the members of the group via the network node 114 over the structured network 112.

In some example embodiments, the community maintenance module 418 may be configured to facilitate remote participance in a community. In this regard, a remote terminal may be located at a location outside of range of the proximity-based communications technology used for communication among members of the ad hoc community at the location at which the community was formed using proximity-based communications. For example, a community may be formed by a group of friends attending a baseball game. However, another friend may not be able to attend the game. Thus, some example embodiments may facilitate remote participance in the community by the friend that is unable to attend the game.

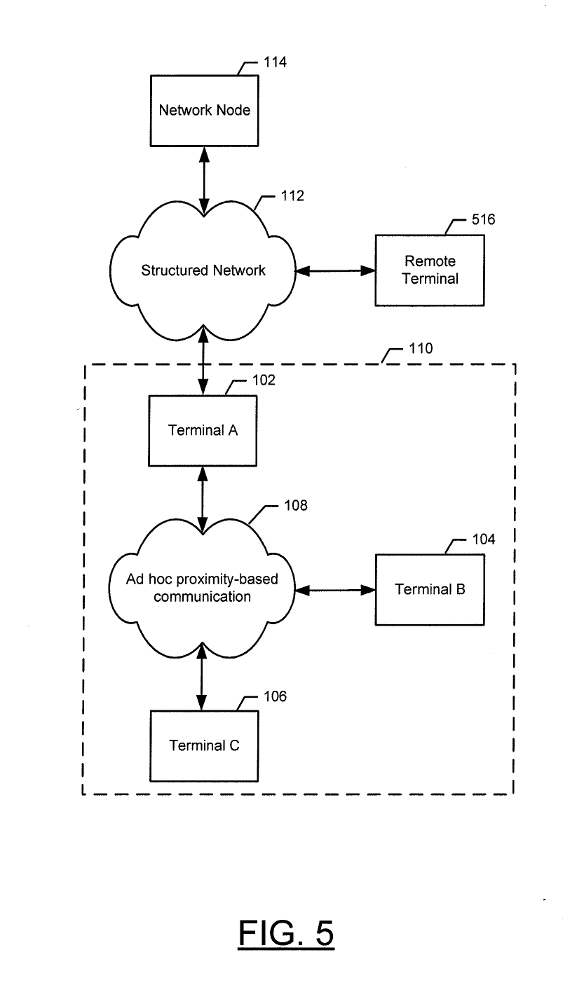

FIG. 5 illustrates an example of facilitating remote participance in a community according to some example embodiments within the context of the system 100 illustrated in FIG. 1. Referring to FIG. 5, a remote terminal 516 is connected to the structured network 112 and, thus, may communicate with the network node 114. The remote terminal 516 may comprise any computing device configured to send and/or receive data over the structured network 112 and may, for example, comprise an embodiment of a terminal apparatus 302. The remote terminal 516 may receive a request to join the community 110, such as by receiving an indication of the community identifier for the community 110. As another example, the remote terminal 516 may utilize a community identifier for the community that may be published by the network node 114 to join the community 110. The remote terminal 516 may be located at a second location that is outside of range of the proximity-based communication 108 used by the terminal A 102, terminal B 104, and terminal C 106 to form the community 110 at a first location.

A community maintenance module 418 that may be associated with the network node 114 may update membership information for the community to include the remote terminal 516. Thus, for example, contact information may be stored for the remote terminal 516 to enable data exchanged in the community to be forwarded to the remote terminal 516.

The remote terminal 516 may send data to the community using the community identifier for the community over the structured network 112. A community maintenance module 418 that may be associated with the network node 114 may receive the data sent by the remote terminal 516. The community maintenance module 418 may use the community identifier to access stored membership information for the community that is associated with the community identifier and may cause the received data to be forwarded from the network node 114 to one or more of the terminals at the location of the community via the structured network 114. In the example of FIG. 5, the network node 114 may cause the data sent by the remote terminal 516 to be forwarded to the terminal A 102.

In some example embodiments, if data sent by a remote terminal, such as the remote terminal 516, to a community is not forwarded by the network node 114 to all other members of the community, the data may be propagated from a receiving terminal to other members of the community via proximity-based communication. For example, using the example illustration of FIG. 5, a community participance module 318 that may be associated with the terminal A 102 may receive data sent to the community by the remote terminal 516 that has been forwarded by the network node 114 over the structured network 112. The community participance module 318 may cause the received data to be propagated to the terminal B 104 and/or the terminal C 106 via ad hoc proximity-based communication 108. Accordingly, the data communicated to the community by a remote terminal may be forwarded by the network node 114 to at least one other member of the community via the structured network 112 and propagated to remaining members of the community through use of proximity-based communication.

In some example embodiments, the community participance module 318 may be configured to cause data exchanged among some members of a community via proximity-based communication to be sent to the network node 114 via the structured network 112 such that the data may be forwarded to a remote participating terminal(s). Thus, for example, using the example of FIG. 5, data exchanged between the terminal A 102, terminal B 104 and terminal C 106 via proximity-based communication 108 may be sent by the terminal A 102 to the network node 114 via the structured network 112. A community maintenance module 418 that may be associated with the network node 114 may receive the data sent by the terminal A 102 and may cause the data to be forwarded to the remote terminal 516 via the structured network 112. In this regard, the community maintenance module 418 may use stored membership information for the community to determine contact information for a remote participant(s) in the community and use the contact information to forward the data to the remote participant(s).

While only a single remote terminal 516 is illustrated in FIG. 5, it will be appreciated that this illustration is by way of example, and not by way of limitation. In this regard, some example embodiments may facilitate remote participance in a community by multiple remote terminals 516. As such, it will be appreciated that in such example embodiments, a first remote terminal participating in a community may send data to a second remote terminal participating in the community (for example, data sent directly to the second remote terminal and/or data sent to the community as a whole) via the network node 114. The community maintenance module 418 may accordingly be configured in some example embodiments, where appropriate, to propagate data sent to and/or exchanged within a community to/from each respective remote terminal participating in the community.

In some example embodiments, the community maintenance module 418 may be configured to facilitate remote maintenance of a community subsequent to one or more members of the community leaving the location at which the community was formed. For example, using the previous example of a community formed by a group of friends attending a baseball game, the members of the community may disperse subsequent to the conclusion of the baseball game. While the members of the community may no longer be able to communicate using proximity-based communication, the community maintenance module 418 of some example embodiments may be configured to use a stored community identifier and associated membership information (for example, contact information for members of the community) to enable communications among members of the community even after the baseball game.

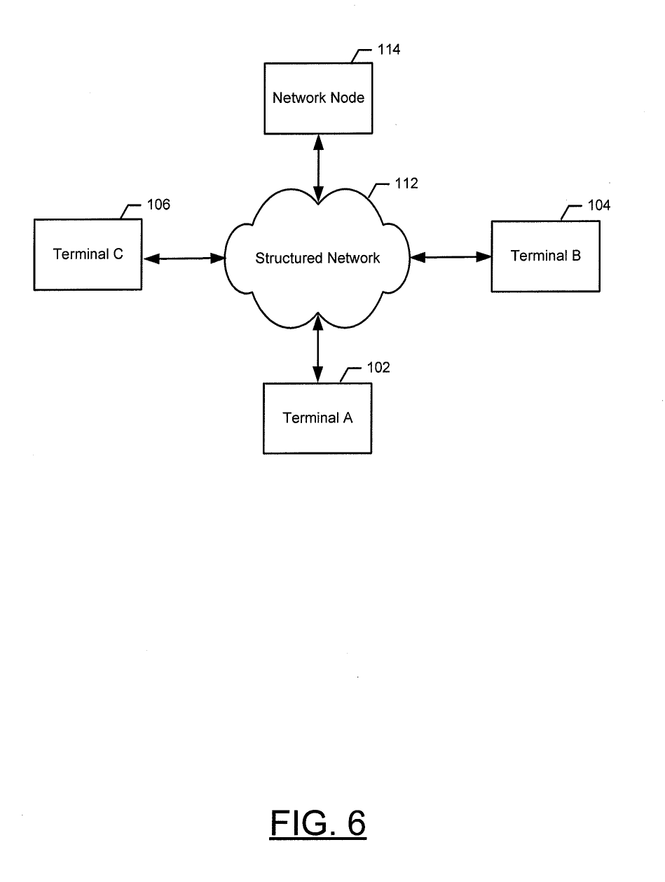

FIG. 6 illustrates an example of maintaining a community according to some example embodiments within the context of the system 100 illustrated in FIG. 1. Referring to FIG. 6, the terminal A 102, terminal B 104, and terminal C 106 are illustrated as being connected to the structured network 112. In this regard, the terminal A 102, terminal B 104, and terminal C 106 may have left the location at which the community 110 illustrated in FIG. 1 was formed, such that they are unable to communicate with each other using proximity-based communication. However, the terminal A 102, terminal B 104, and terminal C 106 may have access to the structured network 112. One or more of the terminal A 102, terminal B 104, and terminal C 106 may use the community identifier for the community to send data to other members of the community via the network node 114. In this regard, for example, a community participation module 318 associated with terminal A 102 may be configured to cause data to be sent to the community using the community identifier. This data may, for example, be sent to the community via the network node 114 over the structured network 112. A community maintenance module 418 that may be associated with the network node 114 may receive the data. The community maintenance module 418 may use the community identifier to access associated membership information for the community to determine contact information for the other members of the community (for example, terminal B 104 and terminal C 106). The community maintenance module 418 may cause the data received from terminal A 102 to be forwarded to the other members of the community (for example, to the terminal B 104 and/or terminal C 106, to users associated therewith, and/or the like) via the structured network 112 using the membership information associated with the community identifier.

In some example embodiments, the community maintenance module 418 may be configured to maintain a log of communication in a community. This log may, for example, be stored in the memory 412. In some such example embodiments, the log may be accessible to users over the structured network 112 such that the user may review communications within a community. In this regard, a log of community communications may, for example, be accessed using a community identifier. In some example embodiments, access to a log of community communications may be available to members of the community. Additionally or alternatively, in some example embodiments, access to a log of community communications may be controlled through access permissions such that a subset of members of the community may be granted access to the log, one or more individuals who are not members of the community may be granted access to the log, and/or the like.

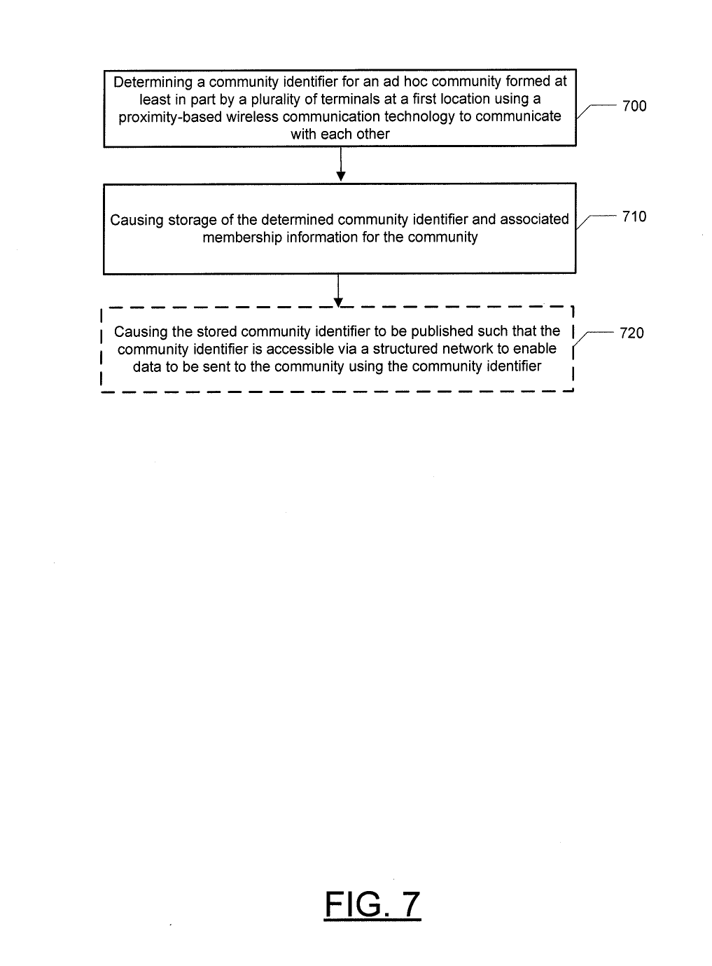

FIG. 7 illustrates a flowchart according to an example method for facilitating remote participance in a community according to some example embodiments. In this regard, FIG. 7 illustrates operations that may be performed at a network node apparatus 402. The operations illustrated in and described with respect to FIG. 7 may, for example, be performed by, with the assistance of, and/or under the control of one or more of the processor 410, memory 412, communication interface 414, or community maintenance module 418. Operation 700 may comprise determining a community identifier for an ad hoc community formed at least in part by a plurality of terminals at a first location using a proximity-based wireless communication technology to communicate with each other. The processor 410, memory 412, communication interface 414, and/or community maintenance module 418 may, for example, provide means for performing operation 700. Operation 710 may comprise causing storage of the determined community identifier and associated membership information for the community. The processor 410, memory 412, communication interface 414, and/or community maintenance module 418 may, for example, provide means for performing operation 710.

The method may optionally further comprise operation 720, which may comprise causing the stored community identifier to be published such that the community identifier is accessible via a structured network to enable data to be sent to the community using the community identifier. The published community identifier and associated stored membership information for the community may be used for facilitating remote participance in the community and/or maintenance of the community in accordance with one or more example embodiments. The processor 410, memory 412, communication interface 414, and/or community maintenance module 418 may, for example, provide means for performing operation 720.

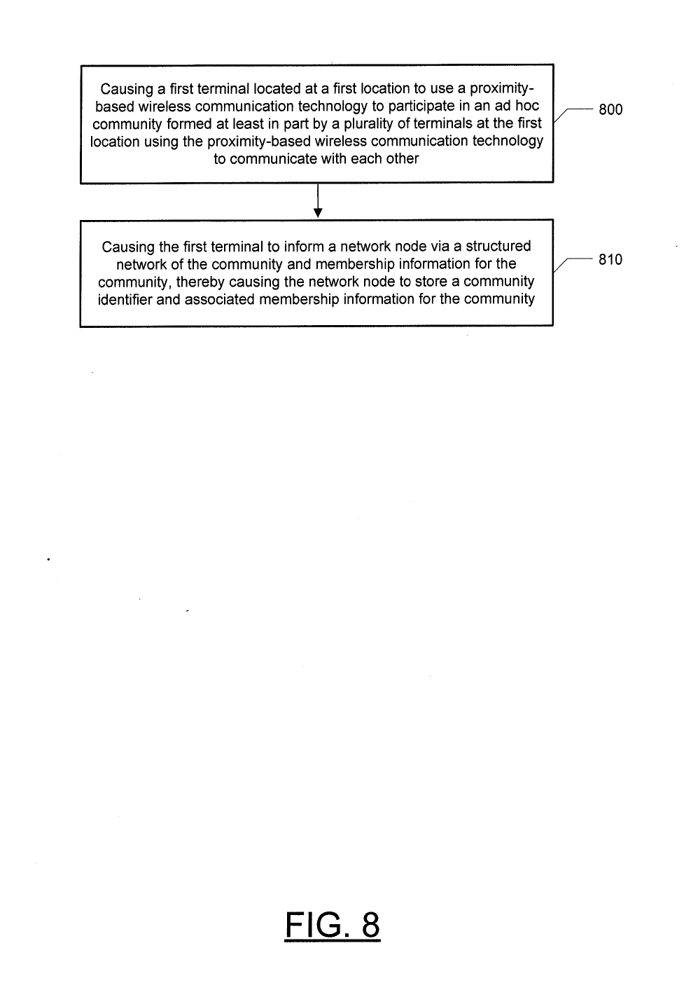

FIG. 8 illustrates a flowchart according to another example method for facilitating remote participance in a community according to some example embodiments. In this regard, FIG. 8 illustrates operations that may be performed at the terminal apparatus 302. The operations illustrated in and described with respect to FIG. 8 may, for example, be performed by, with the assistance of, and/or under the control of one or more of the processor 310, memory 312, communication interface 314, user interface 316, or community participance module 318. Operation 800 may comprise causing a first terminal located at a first location to use a proximity-based wireless communication technology to participate in an ad hoc community formed at least in part by a plurality of terminals at the first location using the proximity-based wireless communication technology to communicate with each other. The processor 310, memory 312, communication interface 314, user interface 316, and/or community participance module 318 may, for example, provide means for performing operation 800. Operation 810 may comprise causing the first terminal to inform a network node via a structured network of the community and membership information for the community, thereby causing the network node to store a community identifier and associated membership information for the community. The network node may accordingly use the stored community identifier and associated membership information to facilitate remote participance in the community by a terminal located at a second location and/or maintenance of the community after one or more of the community members have left the first location. The processor 310, memory 312, communication interface 314, and/or community participance module 318 may, for example, provide means for performing operation 810.

FIGS. 7-8 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 312 and/or in the memory 412) and executed by a processor in the computing device (for example, by the processor 310 and/or by the processor 410). In some example embodiments, the computer program instructions comprising the computer program product(s) which embody the procedures described above may be stored by memory devices of a plurality of computing devices. As will be appreciated, any such computer program product may be loaded onto a computer or other programmable apparatus (for example, a network node apparatus 402, terminal apparatus 302, and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a network node apparatus 402, terminal apparatus 302, and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. According to some example embodiments, a suitably configured processor (for example, the processor 310 and/or processor 410) may provide all or a portion of the elements. In other example embodiments, all or a portion of the elements may be configured by and operate under control of a computer program product. The computer program product for performing the methods of some example embodiments may include a computer-readable storage medium (for example, the memory 312 and/or the memory 412), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
determining, at a network node accessible via a structured network, a community identifier for an ad hoc community formed at least in part by a plurality of terminals at a first location using a proximity-based wireless communication technology to communicate with each other; and
causing storage at the network node of the determined community identifier and associated membership information for the community, the membership information comprising contact information associated with at least one of the plurality of terminals.

2. The method of claim 1, further comprising:
facilitating, at the network node, participation by a remote terminal located at a second location in the ad hoc community via the structured network based at least in part on the stored community identifier and the associated membership information, wherein the second location is outside of range of the proximity-based wireless communication technology used by the plurality of terminals at the first location.

3. The method of claim 2, wherein facilitating participation comprises:
receiving, at the network node via the structured network, data sent by the remote terminal to the community using the community identifier; and
using the stored membership information associated with the community identifier to cause the received data sent by the remote terminal to be forwarded from the network node to one or more of the plurality of terminals at the first location.

4. The method of claim 2, wherein facilitating participation comprises:
receiving, at the network node, data sent to the network node by a first terminal of the plurality of terminals at the first location, the data having been exchanged between the first terminal of the plurality of terminals at the first location and at least one second terminal of the plurality of terminals at the first location using the proximity-based communication technology; and
causing the received data sent by the first terminal of the plurality of terminals at the first location to be forwarded to the remote terminal via the structured network.

5. The method of claim 2, further comprising causing storage of contact information associated with the remote terminal as membership information in association with the community identifier.

6. The method of claim 1, further comprising, subsequent to at least one of the plurality of terminals leaving the first location, facilitating, by the network node via the structured network, communication between members of the ad hoc community based at least in part on the stored community identifier and the associated membership information.

7. The method of claim 6, wherein facilitating communication between members of the community subsequent to at least one of the plurality of terminals leaving the first location comprises:
receiving, at the network node via the structured network, data sent to the community using the community identifier; and
using the stored membership information associated with the community identifier to cause the received data to be forwarded from the network node to one or more members of the community.

8. The method of claim 1, wherein at least one of the plurality of terminals at the first location is connected to the structured network.

9. The method of claim 1, further comprising causing the community identifier to be published such that the community identifier is accessible via the structured network to enable data to be sent to the community using the community identifier.

10. The method of claim 1, wherein the network node comprises a server.

11. The method of claim 1, wherein the structured network via which the network node is accessible comprises one or more of a cellular network or the Internet.

12. An apparatus comprising at least one processor and at least one memory storing computer program code, wherein the at least one memory and stored computer program code are configured, with the at least one processor, to cause the apparatus to at least perform:
determining a community identifier for an ad hoc community formed at least in part by a plurality of terminals at a first location using a proximity-based wireless communication technology to communicate with each other, wherein the apparatus is accessible via a structured network; and
causing storage of the determined community identifier and associated membership information for the community, the membership information comprising contact information associated with at least one of the plurality of terminals.

13. The apparatus of claim 12, wherein the at least one memory and stored computer program code are configured, with the at least one processor, to further cause the apparatus to perform:
facilitating participation by a remote terminal located at a second location in the ad hoc community via the structured network based at least in part on the stored community identifier and the associated membership information, wherein the second location is outside of range of the proximity-based wireless communication technology used by the plurality of terminals at the first location.

14. The apparatus of claim 13, wherein facilitating participation comprises:
receiving, via the structured network, data sent by the remote terminal to the community using the community identifier; and
using the stored membership information associated with the community identifier to cause the received data sent by the remote terminal to be forwarded to one or more of the plurality of terminals at the first location.

15. The apparatus of claim 13, wherein facilitating participation comprises:
receiving data sent by a first terminal of the plurality of terminals at the first location, the data having been exchanged between the first terminal of the plurality of terminals at the first location and at least one second terminal of the plurality of terminals at the first location using the proximity-based communication technology; and
causing the received data sent by the first terminal of the plurality of terminals at the first location to be forwarded to the remote terminal via the structured network.

16. The apparatus of claim 12, wherein the at least one memory and stored computer program code are configured, with the at least one processor, to further cause the apparatus to perform causing storage of contact information associated with the remote terminal as membership information in association with the community identifier.

17. The apparatus of claim 12, wherein the at least one memory and stored computer program code are configured, with the at least one processor, to further cause the apparatus to perform, subsequent to at least one of the plurality of terminals leaving the first location, facilitating communication between members of the ad hoc community via the structured network based at least in part on the stored community identifier and the associated membership information.

18. The apparatus of claim 16, wherein facilitating communication between members of the community subsequent to at least one of the plurality of terminals leaving the first location comprises:
receiving, via the structured network, data sent to the community using the community identifier; and
using the stored membership information associated with the community identifier to cause the received data to be forwarded to one or more members of the community.

19. The apparatus of claim 12, wherein at least one of the plurality of terminals at the first location is connected to the structured network.

20. The apparatus of claim 12, wherein the at least one memory and stored computer program code are configured, with the at least one processor, to further cause the apparatus to perform causing the community identifier to be published such that the community identifier is accessible via the structured network to enable data to be sent to the community using the community identifier.

21. (canceled)

22. The apparatus of claim 12, wherein the structured network via which the apparatus is accessible comprises one or more of a cellular network or the Internet.

23-51. (canceled)
